(19) United States
(12) Patent Application Publication
(10) Pub. No.: US 2008/0133577 A1
(43) Pub. Date: Jun. 5, 2008

(54) Transaction Message Adaptation System For Use In Inter-System Data Exchange

(75) Inventors: Julianne Noonan, Boyertown, PA (US); Maryann Feng, Exton, PA (US); Richard J. Gengler, West Chester, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., Malvern, PA (US)

(21) Appl. No.: 11/936,463

(22) Filed: Nov. 7, 2007

Related U.S. Application Data
(60) Provisional application No. 60/864,642, filed on Nov. 7, 2006.

(51) Int. Cl. G06F 17/30

(52) U.S. Cl. 707/102; 707/E17.005

(57) ABSTRACT

An adaptive data exchange system for exchanging data between different electronic data systems is described herein to include an input processor for automatically acquiring a description of data to be conveyed in a transaction message comprising data elements. The description of data indicates a sequence of data items conveyed in the transaction message and a data format of individual data items conveyed in the transaction message. A data processor parses the description of data to identify individual data elements, and maps the individual data elements to corresponding data element fields in a transaction message specific format description. The transaction message specific format description is used to generate at least one of (a) an inbound transaction, (b) an outbound, transaction message and (c) both inbound and outbound transactions. A message generator uses the transaction message specific format description, identified using a transaction identifier, to generate a transaction message for communication to a remote destination in response to receiving an inbound transaction message having the transaction identifier.

This is a non-provisional application of provisional application Ser. No. 60/864,642, filed Nov. 7, 2006, by Julianne Noonan et al.

### FIELD OF THE INVENTION

The present invention relates to exchange of transaction messages, and more particularly relates to an adaptive data exchange system for exchanging transaction messages between electronic data systems.

### BACKGROUND OF THE INVENTION

Computerized user interface database systems are known and used as information repositories. Information is stored in information repositories and other databases for use with electronic data systems, for example, information necessary to operate the systems. Configuration data for controlling a new operational mode of an electronic data system, or executable application is entered into the database or information repository. The user interface database systems operate to retrieve the information and configuration data from such computerized databases or other information repositories, and facilitate exchanging data between the different electronic data systems and executable applications.

The OPENLink system by Siemens Medical Systems, Inc. is one known user interface database system. The Siemens OPENLink user interface database system is an executable application that facilitates and integrates exchange of data in forms of transaction messages, and monitors the exchange of transaction messages among different electronic data systems. The Siemens OPENLink system operates an integration engine that integrates the various protocols of transaction messages exchanged between and among electronic data systems, where a data exchange is a transaction that includes communicating a transaction message.

In order for the system to operate data exchange with electronic data systems, endpoints of communication between the system and the electronic data systems are configured as inbound and outbound connections. A connection as used in this context represents an object definition within the system that is either responsible for inbound connectivity to the system from a source electronic data system, or for outbound connectivity from the system to a destination electronic data system. Configured connection definitions are stored for use by the system repository. A transaction message from a source electronic data system to the integration engine is sent via an inbound connection. A transaction message to a destination electronic data system from the integration engine is sent via an outbound connection.

In a transaction, one electronic data system or executable application transmits data in a transaction message comprising a predetermined data format to the system. The data or transaction message is sent to the system via a configured inbound connection. The system processes, integrates and routes this message data to a destination electronic data system in a second transaction message form comprising a predetermined data format. The second predetermined data format may differ from the first predetermined data format. The system acts as a transaction message interface to integrate data exchange between electronic data systems, including accommodating differences in data format, communications medium and protocol. In known systems, a user interfaces with the system to manually configure the transaction description for individual transactions or exchanges, including configuring the data type properties for the various nodes. This process is time consuming and also prone to error.

A system according to inventive principles addresses these deficiencies and related problems.

### SUMMARY OF THE INVENTION

The system uses preconfigured transaction message specific format descriptions. Individual inbound and outbound connections or links from and to an electronic data system identifies individual inbound and outbound transactions to enable predefined transaction message reformatting, or routing. The reformatting or routing requires a particular transaction specific format description, when XML data is utilized for the data exchange via the inbound and outbound configured connections. When XML data is used for data exchange in a transaction, individual transaction descriptions are composed as a valid XML document structure for data exchange with an electronic data system via a respective inbound and outbound connection. Composing or creating XML transaction descriptions used in transaction message exchange by known user interface database systems is a time consuming process. XML transaction descriptions comprise schema or structure that can have thousands of data elements, identified as nodes in XML nomenclature. The data elements are arranged in a sequential tree structure. Individual nodes or data elements comprising a transaction description is defined as a node or data element type. Node type descriptions include various types of information such as min/max size, default values, data type, patterns, fixed values, mandatory indictors, etc.

An adaptive data exchange system for exchanging data between different electronic data systems is described herein to include an input processor for automatically acquiring a description of data to be conveyed in a transaction message comprising data elements. The description of data indicates a sequence of data items conveyed in the transaction message and a data format of individual data items conveyed in the transaction message. A data processor parses the description of data to identify individual data elements, and maps the individual data elements to corresponding data element fields in a transaction message specific format description. The individual data elements parsed and decoded from the description of data are saved in a persistent store. The transaction message specific format description indicates a message format composed for use as a role in one of at least one of, (a) an inbound transaction message, (b) an outbound transaction message and (c) both inbound and outbound transaction messages. A message generator uses the transaction message specific format description and transaction identifier to identify source transactions and/or to generate a transaction message for communication to a remote destination in response to receiving an inbound transaction message having the transaction identifier.

### BRIEF DESCRIPTION OF THE DRAWING FIGURES

In order that the manner in which the above recited and other advantages of the invention may be obtained, a more particular description of the invention briefly described above is rendered by reference to specific embodiments thereof that are illustrated in the appended drawings. Understanding that these drawings depict typical embodiments of the invention and are not therefore to be considered to be limiting of its scope, the invention is described and explained with additional specificity and detail through use of the accompanying drawings in which:

FIG. 1 is a schematic block diagram depicting an adaptive data exchange system;

FIG. 2 is a display image presented to a user to import a description of data (or acquired schema) and compose a transaction description corresponding to the acquired schema for use in generating transaction messages; and

FIG. 3 is database definition of the transaction description of FIG. 2;

FIG. 4 is a display image presented to a user in order to select various element types that are included in a transaction message description;

FIG. 5 is a display image presenting a hierarchical tree structure view, and corresponding data structure view of a transaction description; and

FIG. 6 is system flow diagram.

### DETAILED DESCRIPTION OF THE INVENTION

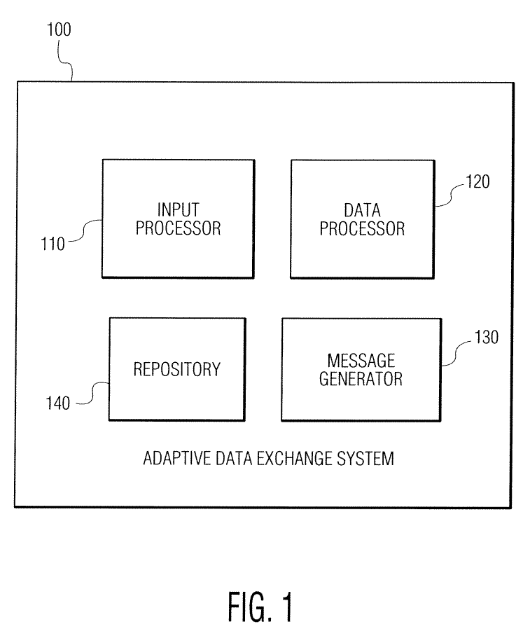

An adaptive data exchange system (100 FIG. 1) exchanges data between different electronic data systems. The adaptive data exchange system is shown in FIG. 1 to include an input processor (110). In order to facilitate adaptive transaction message data exchange for communications between the different electronic data systems, the input processor automatically acquires a description of data to be conveyed in a transaction message. The description of data comprises data elements that indicate a sequence of data items conveyed in the transaction message from an electronic data system, and the data format of the individual data items. A data processor (120) parses the acquired description of data to identify its individual data elements, for example, nodes in the description of data. The data processor maps the individual data elements to corresponding data element fields in a transaction message specific format description for the electronic data system. The transaction message specific format description (used interchangeably herein with “transaction description”) indicates message formats for at least one of an inbound and outbound transaction message. A transaction identifier is used to identify individual transaction descriptions for intended adaptive data exchange system operation.

Individual transaction message specific format description for individual inbound and outbound connections for an electronic data system includes data element fields, e.g., nodes, and data about the data element fields, e.g., formatting data for the data fields or nodes. A message generator (130) responds to an inbound transaction message initiated from a source electronic data system. The message generator uses a transaction identifier in the inbound transaction message to identify a transaction message specific format description associated with the electronic data system. Based on the transaction description, the message generator generates a transaction message for communication to a remote destination, for example, a destination electronic data system or application. A repository (140) maintains transaction descriptions for the different transaction messages. The transaction descriptions are recalled to define the format of inbound and outbound data, or transaction messages, exchanged between the various electronic data systems. The adaptive data exchange system operates an XML to XML interface, a non-XML to XML interface, and an XML to non-XML interface, for example.

As used herein, a transaction message description of data is an application specific file descriptor in the format of an inbound or outbound transaction message for exchange with an electronic data system or application. A description of data for an electronic data system is not the data content of a transaction message, but an XML schema used to convey the data content comprising a transaction message. An XML schema or description of data as used herein is a type of XML document expressed in terms of constraints on the structure (XML schema structure) or XML schema type. The constraints for a particular XML schema type (or transaction message) are a predefined subset of basic syntax constraints imposed by the XML schema structure.

Adaptive data exchange system (100) and data processor (120) provide a user interface that allows users to select types of data element fields corresponding to the sequence of data elements decoded from the acquired XML schema or description of data. Because the description of data is automatically acquired, all of the data elements indicating the sequence of data items conveyed in associated transaction messages, and data format of the individual data items are available for mapping to or composing a transaction message. Programmatically importing the description of data, and mapping transaction descriptions therefrom ensures that transaction descriptions are consistently substantially error free, and obviates much of the manual composing needed to compose transaction descriptions for transaction messages in known user interface database systems. A good deal of transaction description composing workflow is carried out automatically by the adaptive data exchange system. Workflow is used herein to mean a task sequence performed by a worker, device or combination of both.

As used herein, a transaction message specific format description comprises data element fields used by the message generator (130) to define how data is formatted, mapped, transposed or transmitted as a transaction message, inbound from an electronic data system and outbound to the electronic data system. Parsing a schema or description of data as used herein means the reading and understanding of the schema document, and processing the data elements within the schema document to map a corresponding transaction description with data elements fields corresponding to the data elements. The transaction description is not data content of a transaction message, but a description of the data elements comprising the form of the data comprising a transaction message

An executable application as used herein comprises code or machine readable instruction for implementing predetermined functions including those of an operating system, healthcare information system or other information processing system, for example, in response to user command or input. An executable procedure is a segment of code (machine readable instruction), sub-routine, or other distinct section of code or portion of an executable application for performing one or more particular processes and may include performing operations on received input parameters (or in response to received input parameters) and providing resulting output parameters. A processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

The adaptive data exchange system (100) operates a display process to provide a system user interface. The system user interface presents at least one display image that allows a user to view a file directory and identifiers for data elements comprising a system schema file, which is a description of data for transaction message exchange with individual electronic data systems. The system user interface executes common functions that in cooperation with the at least one display image acquire the schemas or descriptions of data to compose the transaction message specific format descriptions. Descriptions of data (i.e., an acquired XML schema file) acquired by input processor (110) are parsed by the data processor (120) by utilizing XML parser API calls, mapping the various data functions into a transaction message specific format description.

The mapping or decoding identifies data elements, including nodes that the acquired XML schema or description of data defines, and accommodates for default data elements with respect to the template for the transaction descriptions. The composed transaction message specific format descriptions track the descriptions of data, or XML schema for the transaction messages exchanged by and among the electronic data systems. The template is parsed by the data processor utilizing the different electronic data system message parser application program interface (API) functions. Individual data element and respective data format is mapped into a transaction message specific format description by data processor (120). Metadata or attribute information useful to adaptive data exchange system operation is extracted from a description of data as it is parsed by the data processor (120). The extracted information is mapped by the data processor to corresponding data element fields that are linked together in a hierarchical tree structure representing the acquired schema or description of data. Any enumerations or patterns, i.e., the data element formats, are stored into data element fields in the transaction description. Preferably, a table memory structure includes individual data element formats for a transaction description.

The data element fields that comprise the hierarchical tree structure of a transaction description correlate hierarchically to the acquired description of data structure, where the data elements correlate to node types. Tree structures comprise linked nodes. Nodes contain values or conditions, or represent other data structures. The upper most node or data element in a data structure or description of data is a root node, where all other nodes in the structure are called “child” nodes. The data element fields in a transaction description are equivalent to node elements comprising the XML description of data. A root node or upper most data element in the description of is designated as the transaction identifier for the mapped transaction description by the data processor (120). The system user interface presents display images that allow a user to support the mapping of descriptions of data to compose the transaction descriptions.

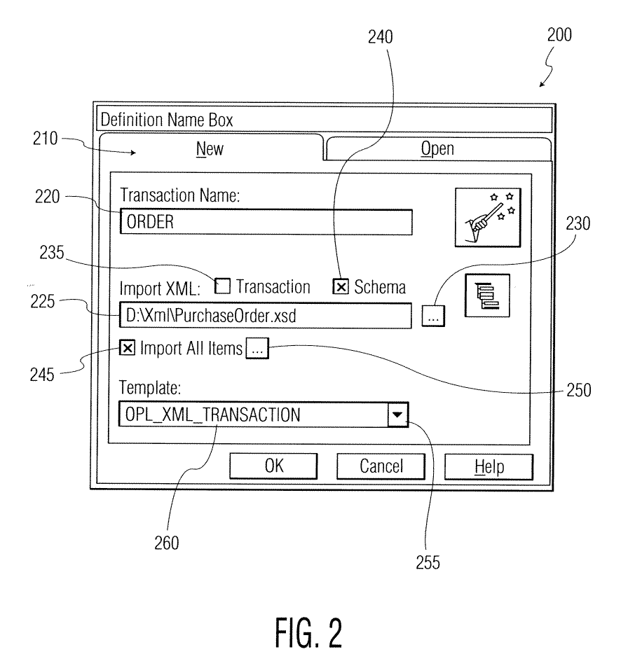

FIG. 2 is a display image (200) of a transaction description (Definition Name Box) presented to a user to compose a transaction message specific format description based on an acquired description of data. A new field (210) comprises various interactive display fields. A display field (220) allows a user to enter a transaction identifier (“Transaction Name”) for a transaction description. A display field (225) allows a user to view and select available XML schemas and transactions to import in cooperation with a display field (230), e.g., (D:\Xml\PurchaseOrder.xsd). Display field (235) is activated to allow the user to import available transactions, and display field (240) is activated to import an available schema, or description of data corresponding to a transaction message to be conveyed. Display field (240) is activated, as indicated by the “x.”

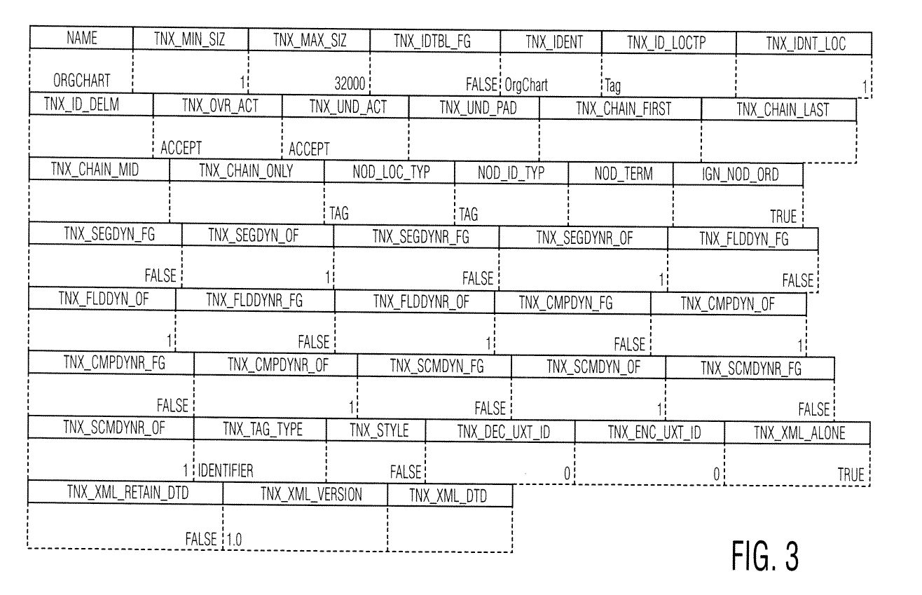

Display field (245) is activated to include a default set of schema data elements. The field is designated as “activated” by the “x” (as shown), whereby all of the default schema types are included in the transaction description. The user may choose to define the transaction description with schema types other than the default types (as described in detail below) by activating display field (250). To view or access a template for the transaction descriptions as described herein, a user activates display field (255). When display field (240) is selected, the template for an XML transaction is automatically selected. FIG. 3 presents a record comprising an acquired XML schema, or description of data, that is, automatically acquired by the input processor (110, FIG. 1) in association with an electronic data system XML data exchange.

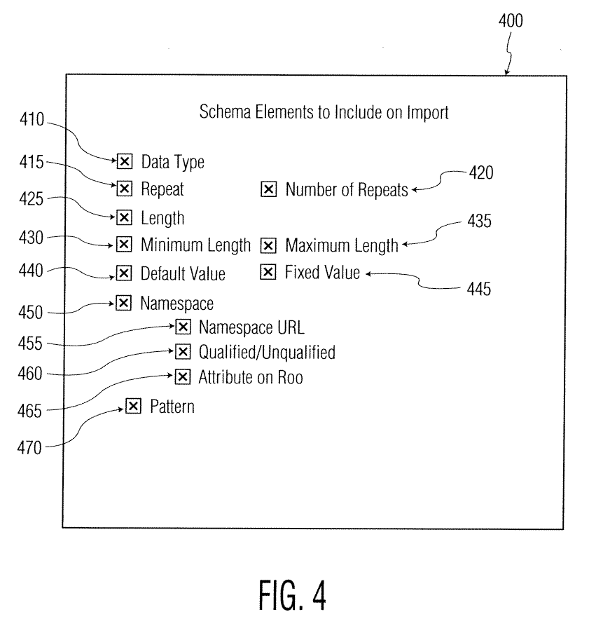

As mentioned, display field (250, FIG. 2) allows the user to see a list of data elements that may be acquired to compose a transaction description. A display image (400) in FIG. 4 is presented to allow the user to select the XML schema elements associated with the data elements, indicative of the sequence of data items and data format for individual data elements or nodes. Individual schema data elements and format types are listed with an associated activation option box display field. In display image (400), the schema elements and associated activation option box display fields include data type (410), repeat (415), number of repeats (420), length (425), maximum length (435), minimum length (430), default value (440), fixed value (445), namespace (450), namespace URL (455), qualified/unqualified (460), attribute on root (465) and pattern (470), which are described in detail below. Display image (400) presents the schema elements in a default state for the transaction description, where the schema element activation display fields are activated to include the schema elements (i.e., default (“x”) in the activation display fields). If the user wishes for one of the displayed schema type to be excluded from the transaction description, they remove the “x.”

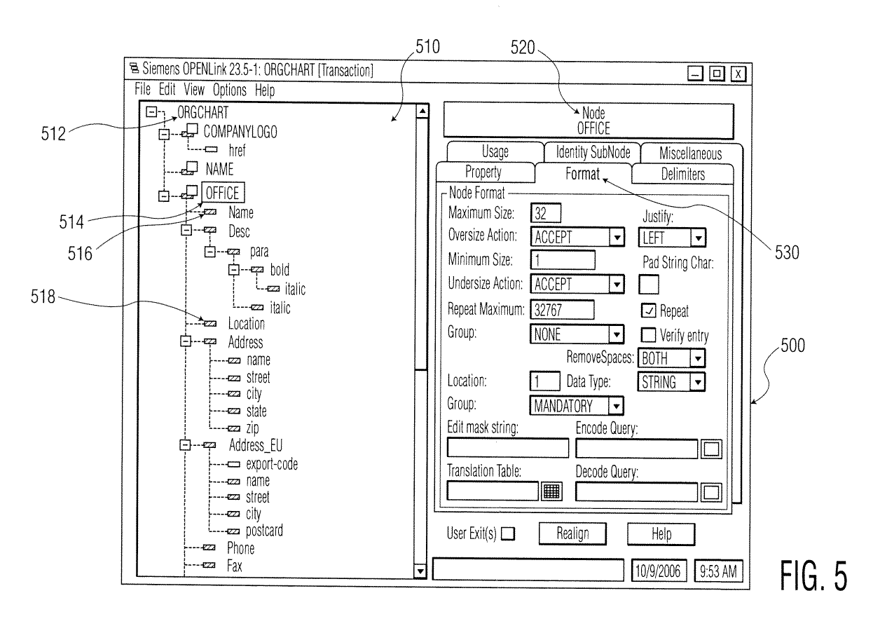

The system allows a user a split view display image (500), presenting one view of a hierarchical tree structure (510) comprising data element fields or nodes for a transaction description. The transaction description is ORGCHART (512), derived from the root node name of the acquired XML schema (described in detail below). The other view (520), presents the node or data element field definitions selected. The node OFFICE, e.g., <xsd:element name=“Office” type=“Office Type” maxOccurs=“unbounded”/, is defined in a portion of XML code included in an appendix to this Detailed Description of the Invention. In the hierarchical tree structure (510), OFFICE (514) is shown activated (by a user), which corresponds to OFFICE data element field or node definition (520), the other view. OFFICE node (520) is mapped to have a maximum occurrence defined as “unbounded.” This data element field translates to “repeat” a maximum number of times (<xsd: element name=“Office” type=“OfficeType” maxOccurs=“unbounded”/>), as shown in the portion of XML code. Various children nodes to the office node are linked in the exemplary hierarchical tree structure form of FIG. 5, e.g., name (516), location (518), etc. The schema data element fields or nodes comprising the node OFFICE (520) are presented as various display fields in the “Format” display field (530) as shown. The various display fields of Format display fields (530) for node OFFICE correspond to the schema data elements or nodes for an acquired description of data.

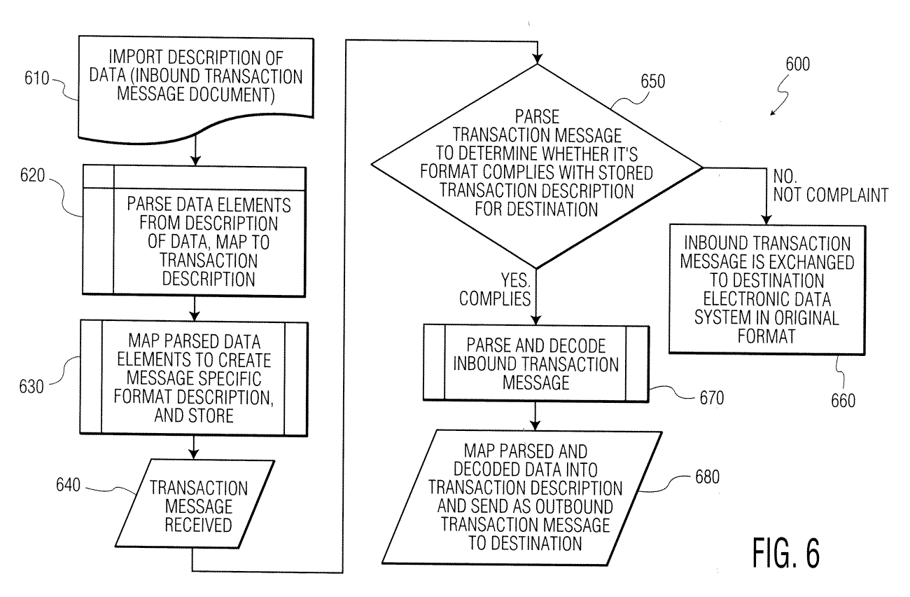

FIG. 6 is a flowchart (600) that illustrates the above-described adaptive data exchange system operation. Flow element (610) represents an operation by which an XML schema document description of data is automatically acquired. Flow element (620) represents an operation by which the acquired description of data is parsed, and data elements or nodes decoded and mapped to corresponding data element fields or nodes in a transaction message specific format description. Flow element (630) involves composing the transaction description that includes mapping, or reformatting the parsed data elements into corresponding data element fields. The format description is stored. Flow element (640) is an operation by which an inbound transaction message is received from a source electronic data system in a respective format of the XML schema description of data, including a transaction identifier, i.e., an inbound transaction message. Decision diamond flow element (650) indicates determining whether the inbound transaction message with transaction identifier complies with the transaction description for the destination (outbound connection).

If the inbound transaction message does not comply with the transaction description for the destination, the adaptive data exchange system sends the data comprising the transaction message to the destination in its received format (660), corresponding to an XML schema, or description of data. That is, the data comprising the inbound transaction message is not reformatted, or mapped to a transaction description. The inbound transaction message is routed to the destination, or outbound connection in its original format. If the inbound description of data is compliant with the stored transaction description for the outbound connection, the inbound transaction message is decoded and parsed, as indicated by flow element (670). The decoded and parsed transaction message data is mapped into to the identified transaction description, as indicated by flow element (680). Mapping the data into the transaction description reformats the inbound transaction message to the transaction message format for the destination.

### Functional Hierarchy

As mentioned above, the hierarchy of data elements and respective formats, and attributes comprising a description of data are mapped into a template for an XML transaction to compose a corresponding transaction message specific format description. The data elements fields or nodes that comprise the transaction description correlate hierarchically to the acquired description of data structure from which it is formed. As mentioned, the root node of the acquired description of data is mapped by the data processor (120, FIG. 1) as a root node or data element filed for the transaction description formed, e.g., the transaction identifier.

### Field Element (Node) Names

The root node is the value at the hierarchical top of the acquired schema or description of data (root name, or root name tag). The root name is an identifier for the acquired XML schema. Transaction identifiers naming transaction descriptions derive from the root name of the corresponding acquired description of data. The transaction identifier ORGCHART (512) was mapped from a description of data's root name “orgchart” for the exemplary transaction description depicted in FIG. 5. The data processor (120) maps root names to UPPERCASE for use as a transaction identifier, e.g., ORGCHART.

### Data Element Types

The root node is the transaction identifier for the transaction description. The root node is linked to top nodes in the transaction description, which are the immediate children of the root node. The data processor (120, FIG. 1) maps node names from the acquired description of data to uppercase as names for corresponding nodes, or data element fields in the transaction description. If the length of a node name in a description of data is greater in character length than the size allowed by the transaction description template, the data processor (120, FIG. 1) truncates, or limits the characters that comprise the mapped node name in the transaction description to those that meet the limit. The characters that exceed the limit are ignored, and do not form part of the mapped node name. A record of the node name is stored in a node identification field in the mapped node. Top nodes in an acquired description of data are mapped as global type nodes or data element fields in the transaction description by the adaptive data exchange system (100, FIG. 1). Nodes linked to top nodes in the description of data are mapped as local nodes and attributes. Global nodes can be used (shared) by other transaction descriptions, but local nodes can exist only within a transaction description.

Data processor (120, FIG. 1) recognizes data element types of individual nodes comprising the XML descriptions of data. For example, XML data types of decimal are recognized as long, integer, short, byte, unsignedLong, unsignedShort, unsigned Integer, positivelnteger, negativelnteger, etc.); where float and double are defined as NUMERIC in the transaction description. XML data types of date, time, dateTime, gYearMonth, gYear, gMonth, gDay, and gMonthDay are defined as DATE in the transaction description. Other XML data types are defined as STRING in the transaction description. XML data type of BOOLEAN are mapped to a data type of STRING in the transaction description where BOOLEAN is not supported by the transaction description template.

### Repeating Nodes

If a data element (node) decoded from an acquired XML description of data has a maximum occurrence value that is greater than one, the node is mapped as a repeating node with a maximum repeat value up to 65,535, in the transaction description. If a data element (node) decoded from an acquired XML description of data has a maximum occurrence value (format) specified as unbounded, the node is mapped as a repeating node with a maximum repeat value of 65,535, in the transaction description. If a data element has a minimum occurrence value defined that it greater than zero, the node is mapped as a MANDATORY node in the transaction description. If an acquired schema data element does not have a minimum occurrence, or has a minimum occurrence of zero, the node is mapped as an OPTIONAL node in the transaction description. If an attribute comprising the acquired description of data (XML schema) is decoded to REQUIRED, the data processor (120) maps the attribute as a mandatory attribute in the transaction description. If an attribute is not defined as REQUIRED, the data processor maps the attribute as OPTIONAL in the transaction description.

### Length

If a length value decoded from an acquired XML description of data (schema), the data processor (120, FIG. 1) maps the data element as a node with the length value in the transaction description. If a length value is not defined in the acquired schema, the data processor defines a length value “1” for the corresponding data element in the transaction description. If a minimum length value is found, the corresponding data element field or node is defined with a specified minimum length value in the transaction description. If the minimum length value is not defined, the data processor defines the node with a minimum length value equal to 1, in the transaction description. If the minimum length is specified, an “undersize action” definition in the transaction description is set to DISCARD. If the minimum length is not specified in the description of data, the undersize action definition is set to ACCEPT. If a maximum length value is included in the acquired description of data (schema), the maximum length field value is mapped to the node in the transaction description. If the maximum value is not defined in the acquired schema, the maximum length value mapped to the node in the transaction description is 32. If the maximum length is specified, an “oversize action” definition in the transaction description is set to DISCARD. If the maximum length is not specified in the description of data, the oversize action definition is set to ACCEPT.

### Default Values

Where the acquired XML description of data includes a default value for a node, the data processor (120, FIG. 1) maps the default value to a specified default value for the node in the transaction description, for example, default=“xx.” Where the description of data includes a fixed value, the data processor maps the fixed value as the default value (for a node or attribute definition) in the transaction description only if the node or attribute is not valued-CLARIFY.

### Selection for Import

As described above with reference to FIGS. 1, 2 and 4, the system (100) allows the user to select schema elements for a transaction description, where schema elements supportable by the transaction description template are included by default. The user de-selects schema elements by clicking on option box activation fields depicted in FIG. 4 for the schema elements the user does not want to include in the transaction description. The user is not required to click on any additional activation or option box fields if they desire to include all supportable schema items in the importation of the schema into the transaction description.

### Exception Processing

The system performs exception processing operation. If mapping a top node in an XML description of data finds that a corresponding node in the transaction description already exists, i.e., is created and identified, the system may replace the existing transaction description name, use the current transaction description name, skip the current transaction description name, or rename the current transaction description. The system recognizes varied cases in text found in the acquired description of data and does not recognize corresponding text for an existing transaction description as a match unless the text case matches. If a user attempts to import a node name with all capital letters that exists in the database in the form of a top node or transaction name, it is recognized as a match.

### Patterns

The system recognizes patterns to be used in tables with a validate operation. The system supports creation of a table for the transaction description using a “pattern value” element decoded from the acquired description of data. Pattern values are placed on both the inbound and outbound sides of translation tables in the transaction description. The name or identification of the table is defined in the transaction description as an element name followed by “_” followed by “Pattern”. Where a pattern element is defined and a table created in the transaction description, the system.activates a “validate option” in a node definition, or “validate option.” Validate is defined by a user by activating (checking) a “validate” box in the transaction description for the node. If a table already exists, the transaction description indicates that the table is new, but identified as needing action in a display image. The user is able to browse the table for that node, and see both the existing and new table with the same name presented in a display image. The user may select whether to use the existing table, replace the existing table, skip or rename by use of the display image.

### Enumeration

When the validate activation field (box) is activated for a transaction definition, and enumeration list is incorporated into the tables. The system creates a table for inclusion using the values in the “enumeration list” items of a schema (FIG. 6). The values are placed on both the inbound and outbound sides of the translation tables in the transaction description. The name of the table is defined as the element name followed by “_” followed by “Enumeration.” Individual items of “Enumeration value” represent one item in the table in the transaction description. Individual enumeration values are not new tables. Where an enumerated list is defined and a table created from the schema, the system highlights the node definition for the transaction description as a “validate” option. If a table already exists, the transaction description is created indicating the new table, but the node is identified as needing action when presented for defining the transaction description. The user is able to browse the table for that node and see both the existing and new table with the same name.

### Order

The adaptive data exchange system supports order functionality (behavior) of an acquired description of data. Where a group indicator is set to “ALL” in the transaction description. The data processor (120, FIG. 1) creates all of the child elements for the group in the transaction description, with “repeat” set to not repeat. Child elements are defined as optional by default. Where a group indicator is set to “CHOICE,” the data processor creates all the child elements included with the acquired schema in the transaction description. Child elements are identified as optional. Where a group indicator is set to “SEQUENCE” in the acquired description of data, the data processor maps the identified child elements in an order specified in the schema but does not validate the order in which they are received. Child elements are identified as optional by default.

A portion of XML code is included in an appendix to this Detailed Description of the Invention, that when processed by the system (100, FIG. 1) coordinates integrated operation by the input processor (110, FIG. 1), data processor (120, FIG. 1) and message generator (130, FIG. 1), including creating and utilizing the transaction descriptions to carry out adaptive data exchange workflow, and transaction messaging.

Although a few examples of the present invention are shown and described, it would be appreciated by those skilled in the art that changes may be made in these embodiments without departing from the principles and spirit of the invention, the scope of which is defined in the claims and their equivalents.

### APPENDIX

<?xml version=“1.0” encoding=“UTF-8”?>
<!-- edited with XMLSPY v2004 beta 1 U (http://www.xmlspy.com) by Altova (Altova) -->
<!-- edited with XML Spy v4.0.1 U (http://www.xmlspy.com) by Vladislav Gavrielov (Altova) -->
<xsd:schema xmlns:ipo=“http://www.altova.com/IPO” xmlns=“http://www.xmlspy.com/schemas/orgchart”
xmlns:xsd=“http://www.w3.org/2001/XMLSchema” targetNamespace=“http://www.xmlspy.com/schemas/orgchart”
elementFormDefault=“qualified” attributeFormDefault=“unqualified”>

<xsd:import namespace=“http://www.altova.com/IPO” schemaLocation=“address.xsd”/>
<xsd:notation name=“Altova-Orgchart” public=“http://www.xmlspy.com/schemas/Altova/orgchart”/>
<xsd:complexType name=“DivisionType”>

<xsd:sequence>

<xsd:element ref=“Name”/>
<xsd:element ref=“Person” maxOccurs=“unbounded”/>

</xsd:sequence>

</xsd:complexType>
<xsd:element name=“OrgChart”>

<xsd:complexType>

<xsd:sequence>

<xsd:element name=“CompanyLogo”>

<xsd:complexType>

<xsd:attribute name=“href” type=“xsd:anyURI”/>

</xsd:complexType>

</xsd:element>
<xsd:element ref=“Name”/>
<xsd:element name=“Office” type=“OfficeType” maxOccurs=“unbounded”/>

</xsd:sequence>

</xsd:complexType>

</xsd:element>
<xsd:element name=“Person”>

<xsd:complexType>

<xsd:complexContent>

<xsd:extension base=“PersonType”/>

</xsd:complexContent>

</xsd:complexType>

</xsd:element>
<xsd:complexType name=“PersonType”>

<xsd:annotation>

<xsd:documentation>A person working for the company</xsd:documentation>

</xsd:annotation>
<xsd:sequence>

<xsd:element name=“First”>

<xsd:annotation>

<xsd:documentation>First (given) name of person</xsd:documentation>

</xsd:annotation>
<xsd:complexType>

<xsd:simpleContent>

<xsd:extenston base=“xsd:string”/>

</xsd:simpleContent>

</xsd:complexType>

</xsd:element>
<xsd:element name=“Last” type=“xsd:string”>

<xsd:annotation>

<xsd:documentation>Last (family) name of person</xsd:documentation>

</xsd:annotation>

</xsd:element>
<xsd:element name=“Title” type=“xsd:string” minOccurs=“0”>

<xsd:annotation>

<xsd:documentation>Academic (or other) title</xsd:documentation>

</xsd:annotation>

</xsd:element>
<xsd:element name=“PhoneExt” type=“xsd:int”>

<xsd:annotation>

<xsd:documentation>Phone extension for direct

dialing</xsd:documentation>

</xsd:annotation>

</xsd:element>
<xsd:element ref=“EMail”/>
<xsd:element name=“Shares” type=“xsd:integer” minOccurs=“0”/>
<xsd:element name=“LeaveTotal” type=“xsd:decimal”/>
<xsd:element name=“LeaveUsed” type=“xsd:decimal”/>
<xsd:element name=“LeaveLeft” type=“xsd:decimal”/>

</xsd:sequence>

</xsd:complexType>
<xsd:simpleType name=“emailType”>

<xsd:restriction base=“xsd:string”>

<xsd:pattern value=“[\p{L}_−]+(\.[\p{L}_−]+)*@[\p{L}_]+(\.[\p{L}_]+)+”/>

</xsd:restriction>

</xsd:simpleType>
<xsd:element name=“Department” type=“DivisionType”/>
<xsd:element name=“Name” type=“xsd:string”/>
<xsd:complexType name=“OfficeType”>

<xsd:sequence>

<xsd:element ref=“Name”/>
<xsd:element ref=“Desc”/>
<xsd:element name=“Location” type=“xsd:string”/>
<xsd:choice>

<xsd:element name=“Address” type=“ipo:US-Address”/>
<xsd:element name=“Address_EU” type=“ipo:EU-Address”/>

</xsd:choice>
<xsd:element name=“Phone” type=“xsd:string”/>
<xsd:element name=“Fax” type=“xsd:string”/>
<xsd:element ref=“EMail”/>
<xsd:element ref=“Department” maxOccurs=“unbounded”/>

</xsd:sequence>

</xsd:complexType>
<xsd:element name=“EMail” type=“emailType”/>
<xsd:element name=“Desc”>

<xsd:complexType>

<xsd:sequence>

<xsd:element ref=“para” maxOccurs=“unbounded”/>

</xsd:sequence>

</xsd:complexType>

</xsd:element>
<xsd:element name=“bold” type=“TextType”/>
<xsd:element name=“italic” type=“TextType”/>
<xsd:complexType name=“TextType” mixed=“true”>

<xsd:choice minOccurs=“0” maxOccurs=“unbounded”>

<xsd:element ref=“bold”/>
<xsd:element ref=“italic”/>

</xsd:choice>

</xsd:complexType>
<xsd:element name=“para” type=“TextType”/>

</xsd:schema>

What is claimed is:

1. An adaptive data exchange system for exchanging data between different electronic data systems, comprising:
an input processor for automatically acquiring a description of data to be conveyed in a transaction message comprising data elements indicating,
(a) a sequence of data items conveyed in said transaction message and
(b) a data format of individual data items conveyed in said transaction message;
a data processor for parsing said description of data to identify individual data elements and mapping said individual data elements to corresponding data element fields in a transaction message specific format description indicating a message format of at least one of, (a) an inbound and (b) and outbound, transaction message, identified by respective transaction identifiers; and
a message generator for, using said transaction message specific format description identified using a transaction identifier, generating a transaction message for communication to a remote destination, in response to receiving an inbound transaction message having said transaction identifier.

2. The adaptive data exchange system of claim 1, further comprising a store for storing transaction message specific format descriptions.

3. The adaptive data exchange system of claim 1, further comprising a display processor to provide at least one display image to enable user interaction with the data processor to map the description of data to the transaction message specific format description.

4. The adaptive data exchange system of claim 1, wherein said description of data to be conveyed in said transaction message comprises an XML schema indicating constraints on message structure and on format of data items conveyed in said message structure.

5. The adaptive data exchange system of claim 1, wherein said transaction message specific format description comprises an Application specific file descriptor indicating format of an inbound or outbound transaction message.

6. The adaptive data exchange system of claim 1, wherein said data processor maps said individual data elements to corresponding data element fields in a transaction message specific format description by generating a hierarchical data structure representation of a structure determined by said description of data.

7. The adaptive data exchange system of claim 1, wherein said data processor translates said hierarchical data structure into a matching data structure compatible with storing said individual data elements in said transaction message specific format description.

8. The adaptive data exchange system of claim 1, wherein said data processor determines if there is a naming conflict between elements including at least one of, (a) a transaction identifier, (b) a data item, (c) a data item attribute and (d) a database table, in storing said individual data elements in said transaction message specific format description.

9. The adaptive data exchange system of claim 1, wherein said transaction message specific format description comprises a hierarchical structure and constraints on a transaction message.

10. The adaptive data exchange system of claim 1, wherein said hierarchical structure and constraints limit use of a transaction description for an exchange of with specified electronic data systems, and to one of and inbound and outbound transaction message.

11. A method for operating an adaptive data exchange interface to integrate exchange of transaction messages by and among electronic data systems, comprising:
automatically acquiring a description of data to be conveyed in a transaction message comprising data elements indicating (a) a sequence of data items conveyed in said transaction message and (b) a data format of individual data items conveyed in said transaction message;
parsing said acquired description of data to identify individual data elements;
mapping said individual data elements to corresponding data element fields in a transaction message specific format description indicating a message format of at least one of, (a) an inbound and (b) and outbound, transaction message, identified by respective transaction identifiers; and
generating a transaction message using said transaction message specific format description identified using a transaction identifier to communicate to an electronic data system in response to receiving an inbound transaction message having said transaction identifier.

12. The method of claim 11, further comprising storing said transaction message specific format description in a store for use in generating a transaction message having said transaction identifier.

13. The method of claim 11, where said description of data to be conveyed in said transaction message comprises an XML schema indicating constraints on message structure and on format of data items conveyed in said message structure.

14. The method according to claim 11, wherein said transaction message specific format description comprises an Application specific file descriptor indicating format of an inbound or outbound transaction message.

15. The method according to claim 11, wherein said mapping maps said individual data elements to corresponding data element fields in a transaction message specific format description by generating a hierarchical data structure representation of a structure determined by said description of data.

16. The method according to claim 15, wherein said mapping translates said hierarchical data structure into a matching data structure compatible with storing said individual data elements in said transaction message specific format description.

17. The method according to claim 11, wherein said mapping determines if there is a naming conflict between elements including at least one of, (a) a transaction identifier, (b) a data item, (c) a data item attribute and (d) a database table, in storing said individual data elements in said transaction message specific format description.

18. The method according to claim 11, further comprising a step of operating a user interface to allow users of the user interface an ability to support the parsing, mapping and generating.

19. The method according to claim 11, wherein said transaction message specific format description comprises a hierarchical structure and constraints on a transaction message.

20. The method according to claim 19, wherein said hierarchical structure and constraints limits use of the transaction description to exchange of data with specific electronic data systems, and to at least one of an inbound and outbound transaction message.
